(19) United States
(12) Patent Application Publication
(10) Pub. No.: US 2007/0239516 A1
(43) Pub. Date: Oct. 11, 2007

(54) Systems and methods for administering survey questionnaires

(76) Inventors: Nigel Graham Smith, Peoria, IL (US); Patricia Sue Bray, Dunlap, IL (US); James Allen Daugherty, Morton, IL (US); Leonard William Fitzpatrick, Washington, IL (US); Gregory Scott Holloway, Metamora, IL (US); Stephen M. Spitzer, Washington, IL (US); Jeremy Paul Gerow, Nashville, TN (US)

Correspondence Address: CATERPILLAR/FINNEGAN, HENDERSON, L.L.P., 901 New York Avenue, NW, WASHINGTON, DC, 20001-4413, US

(21) Appl. No.: 11/392,770

(22) Filed: Mar. 30, 2006

(51) Int. Cl. G06F 17/30

(52) U.S. Cl. 705/10

(57) ABSTRACT

A system for administering a survey questionnaire is provided. The system may include computer readable media for storing a plurality of content pages, the content pages including a survey questionnaire. A host hosts the content pages on a network, and receives and stores responses to survey questions. A terminal is provided for accessing the content pages over the network. The terminals include a browser application for accessing the content pages. The content pages are identified in a file. A security application prevents the browser application from accessing network content other than the content pages identified in the file. The terminals further include a graphical user interface, including a display for displaying a content page to a survey respondent and a user input device for providing an indication of a survey respondent's response to a question. The browser application transmits the response indication to the host over the network.

### TECHNICAL FIELD

The present disclosure is directed to systems and methods for market research and, in particular, to systems and methods for administering survey questionnaires.

### BACKGROUND

Businesses often sponsor market research in order to gather information regarding their customers' needs, and to stay better informed about the image of their brand in the marketplace. Traditionally, such research was conducted through in-person or telephone interviews. However, such techniques require interviewers fluent in each of the languages spoken by the business' customers. In today's global marketplace, this can present a serious burden to the survey sponsor. Further, in personal interviews, the interviewee's responses may be subtly influenced by the interviewer's personality or technique. Paper or web-based surveys may eliminate this bias. However, such techniques present their own problems.

For example, in order to ensure that they are obtaining the opinions of the people who actually make the relevant business decisions, a survey sponsor may request that their survey be completed by a certain target respondent, such as their customers' purchasing agents. However, with traditional paper and web-based survey techniques, the buyer cannot be sure that the target respondent did not delegate completion of the survey to another. In addition, traditional paper and web-based surveys allow the survey questions to be copied by the respondent. Consequently, because an astute observer may be able to predict a business' future plans based on the questions it asks its customers, businesses are unwilling to ask certain types of questions in paper or web-based surveys. Web-based techniques present further problems in that the target respondents may have varying degrees of familiarity with computer keyboards.

Prior art market research methods have been developed in an attempt to improve upon these traditional techniques. For example, U.S. Pat. No. 6,381,744 describes an automated survey kiosk in which respondents may answer survey questions presented on a touch screen display. The survey questions are downloaded to the kiosk prior to administration of the survey. The respondents' answers are aggregated in the kiosk's local memory and the results are periodically transmitted to the survey sponsor via the Internet or facsimile. Encryption algorithms are used to prevent unauthorized access to the survey questions and answers stored in the kiosk's memory.

However, while the '744 patent's use of a touch screen interface may facilitate use by respondents unfamiliar with computer keyboards, the local storage of survey questions and answers presents additional challenges. Specifically, communications problems may prevent the survey questions from being updated in a timely manner, or cause a loss of the aggregated data. Further, the local storage of survey questions and aggregated answers require a significant investment in hardware and software for each kiosk.

The presently disclosed systems and methods for administering survey questionnaires are directed to solving one or more of these shortcomings of the prior art survey techniques.

### SUMMARY OF THE INVENTION

In one aspect, the present disclosure is directed to a system for administering a survey questionnaire. The system includes computer readable media for storing a plurality of content pages, the content pages including a survey questionnaire comprising a plurality of survey questions. A host hosts the plurality of content pages on a network, and receives and stores responses to survey questions. A terminal accesses the plurality of content pages over the network. The terminals include a browser application for accessing the plurality of content pages over the network. The plurality of content pages are identified in a file. A security application prevents the browser application from accessing network content other than the content pages identified in the file. The terminals further include a graphical user interface, including a display for displaying a content page to a survey respondent and a user input device for providing an indication of a survey respondent's response to a survey question displayed on a content page. The browser application transmits the response indication to the host over the network.

In another aspect, the present disclosure is directed to a method for administering a survey questionnaire using a host and a terminal. The method includes hosting a plurality of content pages on a network, the content pages including a survey questionnaire comprising a plurality of survey questions. The content pages are identified in a file. The content pages are accessed over the network using a browser application at the terminal. The browser application is prevented from accessing network content other than the content pages identified in the file. A content page is displayed to a survey respondent at the terminal. An indication of a survey respondent's response to a survey question displayed on a content page is received at the terminal. The response indication may be transmitted to the host over the network. The response to the survey question is received and stored at the host.

In a further aspect, the present disclosure is directed to a computer-readable media containing instructions for configuring a host and a terminal to perform a method for administering a survey questionnaire. The method includes hosting a plurality of content pages on a network, the content pages including a survey questionnaire comprising a plurality of survey questions. The content pages are identified in a file. The content pages are accessed over the network using a browser application at the terminal. The browser application is prevented from accessing network content other than the content pages identified in the file. A content page is displayed to a survey respondent at the terminal. An indication of a survey respondent's response to a survey question displayed on a content page is received at the terminal. The response indication may be transmitted to the host over the network. The response to the survey question is received and stored at the host.

### BRIEF DESCRIPTION OF THE DRAWINGS

FIG. 1A illustrates an exemplary system environment 100, consistent with the present disclosure;

FIG. 1B shows a block diagram of an exemplary terminal, consistent with the present disclosure;

FIG. 2A illustrates the contents of an exemplary terminal storage device, consistent with the present disclosure;

FIG. 2B illustrates the contents of an exemplary host storage module, consistent with the present disclosure;

FIGS. 3A and 3B show exemplary survey pages, consistent with the present disclosure;

FIGS. 4A and 4B show exemplary wrapper pages, consistent with the present disclosure; and

FIG. 5 is a flow chart that illustrates an exemplary method for administering a survey questionnaire, consistent with the present disclosure.

### DETAILED DESCRIPTION

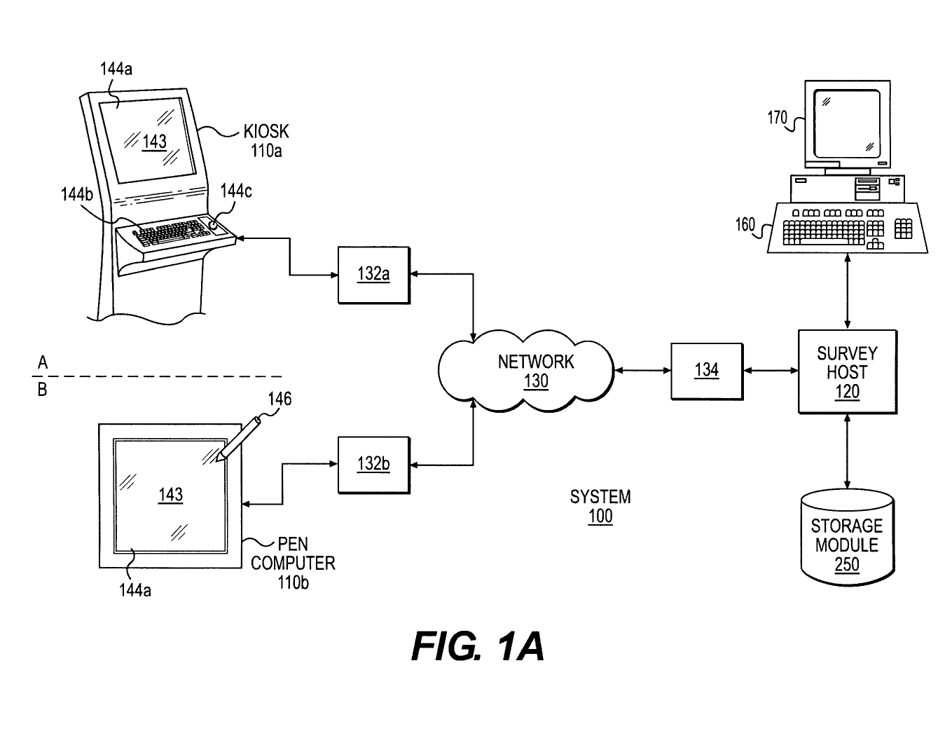

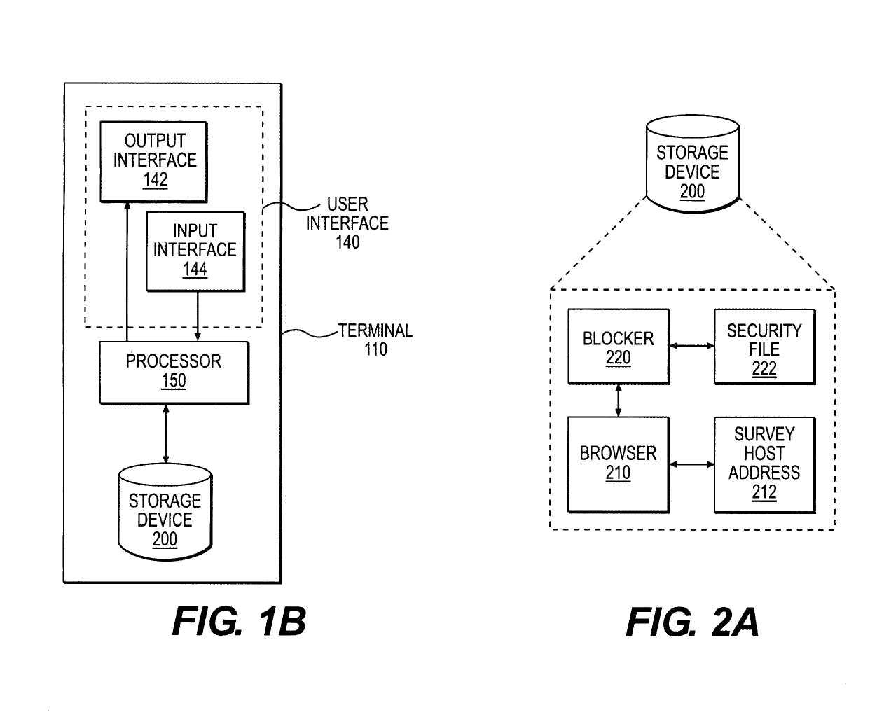

FIG. 1A illustrates an exemplary system environment 100 in which features and principles of the present disclosure may be implemented. As illustrated in FIG. 1A, system 100 may include one or more terminals 110 operatively linked to a survey host 120 via a network 130. In an exemplary embodiment, survey host 120 may host one or more content pages comprising a survey questionnaire. A target respondent may use terminal 110 to access these survey pages and respond to questions in the survey questionnaire. Survey host 120 may collect and analyze respondents' answers to the survey questions.

As shown in FIG. 1A, one or more terminals 110 may be located in a plurality of geographically distributed locations A, B. In an exemplary embodiment, one or more terminals 110 may be placed in locations frequented by the target respondents. For instance, where the target respondents include the survey sponsor's potential customers, one or more terminals 110 maybe located at the sponsor's dealer, retailer and/or manufacturing locations. Where the target respondents include the survey sponsor's existing customers, one or more terminals 110 may further be located at the sponsor's service locations. In addition, although FIG. 1A shows two terminals 110a, 110b in two locations A, B, it is to be understood that terminals 110 may be placed in more (or fewer) locations, and that one or more terminals 110 may be placed at each location.

Network 130 may include any type of network, or combination of networks, that may facilitate communications between survey host 120 and one or more terminals 110. Network 130 may include wired and/or wireless networks. In an exemplary embodiment of the present disclosure, terminals 110 may be linked to survey host 120 via the Internet. However, in other embodiments, network 130 may be implemented using another type of network, such as a telephone-based network (such as PBX or POTS), a local area network (LAN), a wide area network (WAN), a dedicated intranet, etc.

Two exemplary embodiments of terminal 110 are shown in FIG. 1A. In one exemplary embodiment, terminal 110 may be implemented using a stand-alone kiosk 110a, such as a self-service kiosk available, e.g., from Kiosk Information Systems, Louisville, Colo. In another exemplary embodiment, terminal 110 may be implemented using a pen computer 110b, such as a tablet PC. Alternatively, terminal 110 may be implemented using a general purpose computer (e.g., a personal computer), a “dumb” terminal, or any other type of terminal capable of performing one or more methods consistent with the present disclosure.

FIG. 1B is a block diagram illustrating the components of an exemplary terminal 110, consistent with the present disclosure. As shown in FIG. 1B, terminal 110 may include a user interface 140, a processor 150, and a storage device 200.

User interface 140 may be implemented using any of a variety of devices configured to provide for communication between system 100 and survey respondents. User interface 140 may include an output interface 142 for communicating system output (e.g., survey questions) to a survey respondent, and an input interface 144 for converting respondent input (e.g., survey responses) to a machine-readable form.

Output interface 142 may be implemented using any of a variety of devices configured to provide system output (e.g., survey questions, instructions, advertisements and/or other information) to a survey respondent. In exemplary terminals 110a, 110b, output interface 142 may be implemented using a display screen 143, such as an LCD or CRT display. In another embodiment, output interface may include speakers (not shown) for audio communication or system output.

Input interface 144 may be implemented using any of a variety of devices configured to convert user input to a form readable by survey host 120. For instance, input interface 144 may be implemented using a keyboard, mouse, touch screen, trackball or other pointing device, speech recording and/or recognition software, and/or any other suitable user input device or application. In an exemplary embodiment, input interface 144 may be implemented using a touch screen interface. For example, exemplary terminals 110a, 110b may be equipped with a touch screen interface 144a actuatable, e.g., by a respondent's finger or a stylus 146. When actuated, touch screen interface 144a may transmit a signal indicative of the location of the touch to survey host 120. Exemplary kiosk 110a may also be equipped with a keyboard 144b and/or a track ball 144c for user input, in addition to touch screen interface 144a.

Processor 150 may be implemented using any of a variety of processors that may be selectively activated or configured by a computer program to perform one or more methods consistent with the present disclosure. For example, processor 150 may be implemented using a general purpose or special purpose microprocessor.

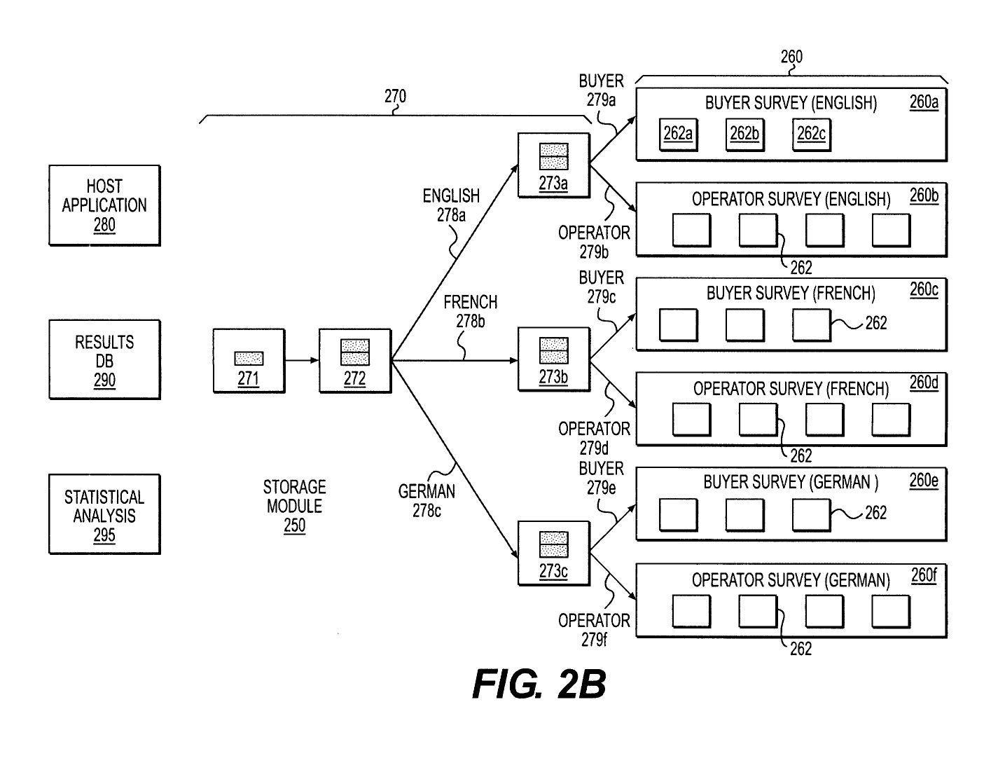

Terminal storage device 200 may include one or more computer readable media encoded with instructions (e.g., an operating system, software applications, etc.) and/or data for use by processor 150 during the performance of one or more of the methods described below. Consistent with the present disclosure, a computer readable medium is any type of media that is capable of carrying instructions or data that may be used by a processor in the performance of one or more of the methods described below. Computer readable media include, for example, physical media (e.g., punch cards), magnetic media (e.g., magnetic disks, tapes, or drives), optical media (e.g., optical disks), or carrier waves (e.g., a signal from another computer or network, such as the Internet). Exemplary contents of storage device 200 are described below in connection with FIG. 2A.

Terminals 110 may communicate with network 130 through respective terminal-side network interfaces 132. Similarly, survey host 120 may communicate with network 130 through a host-side network interface 134. Terminal-side interfaces 132 and host-side interface 134 may be implemented, e.g., using routers or modems. In an exemplary embodiment, network interfaces 132 and 134 may include security apparatus and/or applications (such as firewalls) for preventing unauthorized access to terminal 110 and host 120, respectively, from network 130. For example, network interface 132 and 134 may authorize access from network 130 only if the user or computer requesting access presents a proper credential, such as a password, token, and/or digital certificate, etc. If the requestor fails to present a proper credential, network interfaces 132 and 134 may deny access to terminal 110 or host 120, respectively.

Survey host 120 may be implemented using a general purpose computer (e.g., a personal computer, server, or mainframe computer) or other computing platform having a processor device (not shown) that may be selectively activated or configured by a computer program to perform one or more functions consistent with the present disclosure. For example, survey host 120 may include a processor, such as a microprocessor, that executes program instructions to perform one or more of the methods described below.

Alternatively, survey host 120 may be implemented using a distributed network of such processors. For example, survey host 120 may include a plurality of computers connected by a network architecture, such as network 130 or another network (not shown). In an exemplary embodiment, survey host 120 may be implemented using a plurality of web servers, so as to provide redundancy in case of failure of one such server. The servers may be load-balanced in order to maximize data throughput to terminals 110.

As shown in FIG. 1A, survey host 120 may be in communication with an input module 160, an output module 170, and a storage module 250. Specifically, survey host 120 may be adapted to process input (e.g., commands, instructions and/or data) received from input module 160. Survey host 120 may be further adapted to provide output (e.g., survey results, reports and/or summaries, etc.) to output module 170 for display and/or printing. Survey host 120 may be further adapted to read, write and/or access instructions or data in storage module 250 during the performance of one or more of the methods described below.

Input module 160 may be implemented using any of a variety of devices configured to provide instructions, data and/or commands to survey host 120 as input. Input module 160 may include a user input device for receiving input from a user. For example, input module 160 may include a keyboard 162 (as illustrated in FIG. 1), a mouse or other pointing device, speech recognition software, and/or any other suitable device or application for configuring user input to be read by survey host 120.

Output module 170 may be implemented using any of a variety of devices configured to provide the output of survey host 120 in a form readable by a user. For example, output module 170 may include a display 172 and/or a printing device (not shown) for receiving output from survey host 120.

Storage module 250 may include one or more computer readable media encoded with instructions (e.g., an operating system, software applications, etc.) and/or data (e.g., survey content and/or results) for use by survey host 110 during the performance of one or more of the methods described below. Survey host 120 may be located in the same location or at a geographically distant location from input module 160, output module 170 and/or storage module 250. In an exemplary embodiment of the present disclosure, survey host 120 may be connected to input module 160, output module 170 and/or storage module 250 through the use of a network architecture, such as network 130 or another network (not shown).

FIG. 2A is a block diagram that illustrates exemplary contents of terminal storage device 200. In an exemplary embodiment, storage device 200 may store a browser application 210 for accessing content pages hosted by survey host 120, and a blocker application 220 for restricting the sites accessible by browser application 210.

Browser application 210 may be implemented using a web browser, such as Microsoft Internet Explorer, Firefox, etc. Browser 210 may maintain a address file 212 containing a network address for an initial content page hosted by survey host 120. On startup of terminal 110, browser 210 may be configured to navigate to the initial content page identified in address file 212.

Blocker application 220 may be implemented using any of a variety of browser restriction or blocking applications operable to restrict the applications that may run on terminal. For example, blocker 220 may prevent terminal from running applications other than browser 210, unless bypassed by a user with administrative privileges over blocker 220. Blocker 220 may further be operable to restrict the network content that browser 210 is allowed to access.

For example, blocker 220 may maintain a security file 222 that defines the content pages or domains that browser 210 may be allowed to access, and further operate to prevent browser 210 from accessing network locations that are not identified in security file 222. For instance, security file 222 may identify an Internet address or domain name for survey host 120, in which case browser 210 may be allowed to access all of the content hosted by survey host 120 under the identified address or domain name. Alternatively, security file 222 may identify one or more sub-addresses or sub-domains of survey host 120, in which case browser 210 may be allowed to access only the content accessible via the identified addresses or domains. In an exemplary embodiment, blocker 220 may be implemented using Kioware browser lockdown software.

FIG. 2B is a block diagram that illustrates exemplary contents of storage module 250 (associated with survey host 120). As shown in FIG. 2B, storage module 250 may include one or more survey questionnaires 260, a wrapper 270 for guiding respondents to the proper questionnaire, a host application 280, a results database 290, and a statistical analysis application 295.

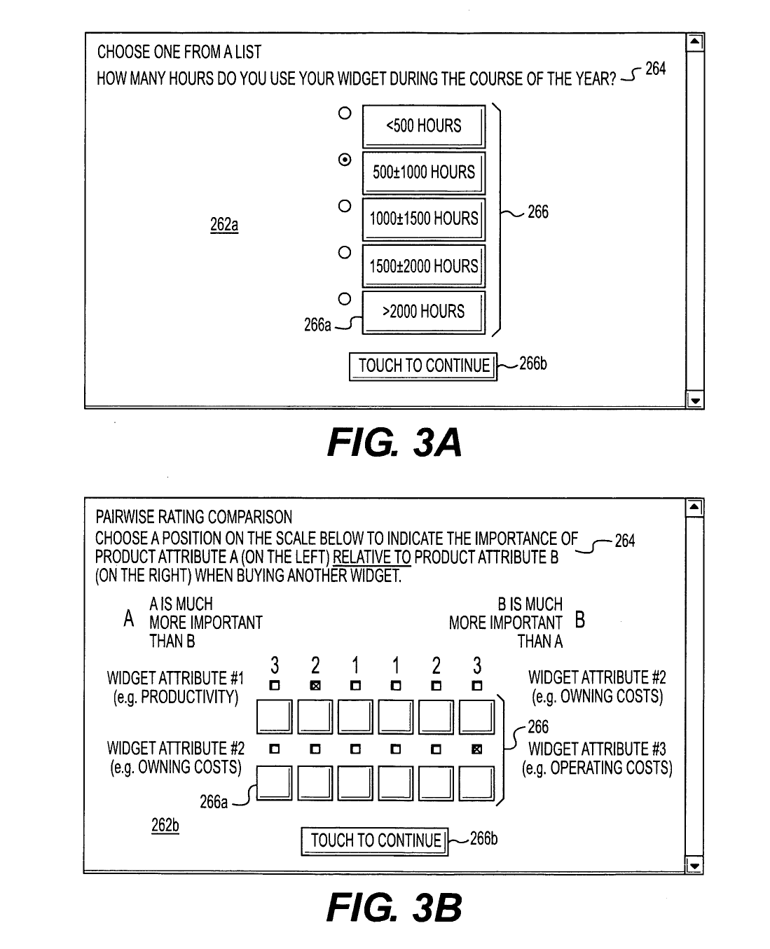

In an exemplary embodiment, each survey questionnaire 260 may include one or more survey pages 262. Survey pages 262 may be constructed as web pages using, e.g., the HTML, JavaScript, and/or Perl protocols. FIGS. 3A and 3B show exemplary survey pages 262a and 262b, respectively, consistent with the present disclosure.

As shown in FIGS. 3A and 3B, survey pages 262 may contain text and/or graphics forming one or more survey questions 264, and a mechanism 266 for the respondent to indicate a response to each survey question. It is to be understood that survey questions 264 illustrated in FIGS. 3A and 3B are exemplary only, and that survey questions 264 may be of any type. For example, survey questions 264 may include multiple-choice questions (e.g., as shown in FIG. 3A), monadic ratings or rankings, pairwise comparisons (e.g., as shown in FIG. 3B), and/or conjoint analyses, etc.

In an exemplary embodiment, the response mechanism 266 may include one or more graphical user inputs (such as check boxes, text boxes, buttons and/or scroll bars, etc.) for indicating the respondent's answer (or answers) to the survey question and a separate graphical user input for submitting the answer to the survey host. As shown in FIGS. 3A and 3B, for example, the response mechanism 266 may include a plurality of answer buttons 266a, and a submit button 266b. Response mechanism 266 may be configured to be actuated using input interface 144. In the exemplary embodiment of FIG. 1A, for example, a survey respondent may actuate answer buttons 266a and submit button 266b using touch screen interface 144a, keyboard 144b and/or track ball 144c. Upon actuation of submit button 266b, survey host 120 may record the response in results database and actuate a link to the next page in survey questionnaire 260, as described below.

Survey questionnaires 260 may include a plurality of questionnaires, e.g., questionnaires 260a-f, related to a sponsor or sponsors. Each of questionnaires 260a-f may be appropriate for a different class of target respondents. In an exemplary embodiment, questionnaires 260a-f may be differentiated by the target respondents' positions, industries, and/or place of business, etc. In FIG. 2B, for example, questionnaires 260a, c, and e may be directed toward the buyers of a certain type of equipment, and questionnaires 260b, d and f may be directed toward the operators of such equipment. In addition, survey questionnaires 260 may include versions translated into several languages. In FIG. 2B, for example, questionnaires 260a and b may be in the English language, questionnaires 260c and d may be in the French language, and questionnaires 260e and f may be in the German language.

Wrapper 270 may be provided to guide respondents to the appropriate questionnaire 260a-f. Wrapper 270 may include an initial wrapper page 271, a first-level wrapper pages 272, and one or more final-level wrapper pages 273. Initial page 271 may display instructions as to how to begin a survey questionnaire 260. For example, in one embodiment of the present disclosure, initial page 271 may present a button labeled “Touch to Begin.” Initial page 271 may also display other information. For example, initial page 271 may display the survey sponsor's logo and/or an advertisement for the survey sponsor's products.

As shown in FIG. 2B, initial page 271 may link to a first-level wrapper page 271, which may link, directly or indirectly, to a plurality of final-level wrapper pages 273a-c. Final-level wrapper pages 273a-c may each link to a subset of survey questionnaires 260a-f. As illustrated in FIG. 2B, for example, final-level wrapper page 273a may link to English language surveys 260a and b; final-level wrapper page 273b may link to French language surveys 260c and d; and final-level wrapper page 273c may link to German language surveys 260e and f.

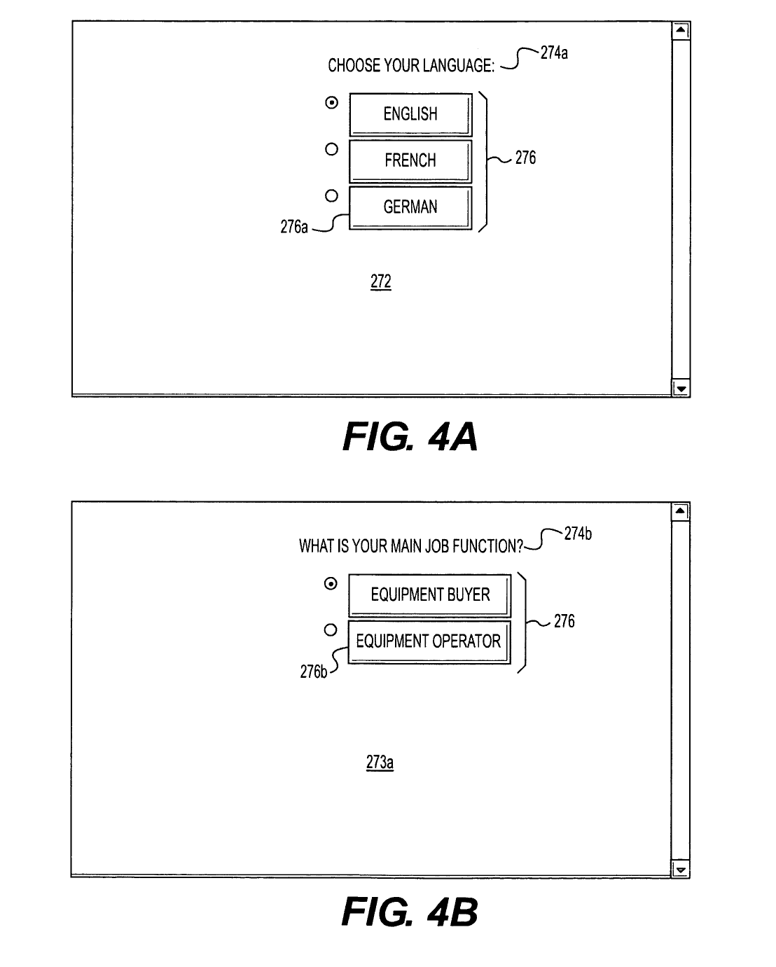

FIG. 4A show an exemplary first-level wrapper page 272, and FIG. 4B shows an exemplary second wrapper page 273a, consistent with the present disclosure. As shown in FIGS. 4A and 4B, each wrapper page 272, 273 may contain a question 274 designed to determine whether the respondent belongs to the class of respondents for which a particular questionnaire (or set of questionnaires) is intended, and one or more response buttons 276. Response buttons 276 may be configured to be actuated in a manner similar to response mechanism 266 (described above). Each response button 276a on first level wrapper page 272 may identify a link 278a-c (see FIG. 2B) to a corresponding wrapper page 273a-e in the next level of wrapper 270. Upon actuation, response button 276a may cause survey host 120 to actuate the corresponding link 278 to the appropriate page 273a-c. Each response button 276b on the final-level wrapper pages may identify a link 279a-f (see FIG. 2B) to a corresponding survey questionnaire 260. Upon actuation, response button 276b may cause survey host 120 to actuate the link 279 to the appropriate survey questionnaire 260a-f.

Host application 280 may be operable to host survey pages 262 and wrapper pages 272 on network 130 and respond to input from browser 210. For example, host application 280 may link browser 210 to appropriate wrapper pages 271-273 or survey pages 262 based on respondent input, as described below.

Results database 290 may be operable to store individual and aggregated responses to survey questionnaires 260. In an exemplary embodiment, survey host 120 may store a record of the responses of each individual survey session, as well aggregated totals for each answer to each question in questionnaires 260. Results database 290 may include a database management system (DBMS) (such as Microsoft Access, Excel, Sybase, Oracle, MySQL, SQL, etc.), that facilitates the location and retrieval of results in database 290.

Statistical analysis application 290 may be operable to provide statistical analysis of the aggregated responses in results database 290. Analysis application 290 may automatically provide reports and/or summaries of survey results periodically to output module 170. Analysis application 290 may be implemented by any of a variety of commercial software applications, such as Sawtooth SSI survey analysis software.

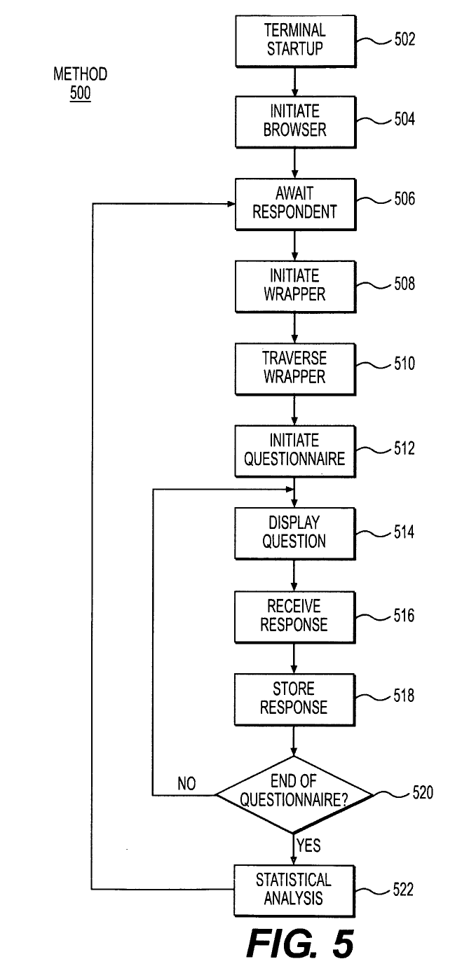

FIG. 5 is a flow chart illustrating an exemplary method 500 for administering a survey questionnaire, consistent with the present disclosure. In an exemplary embodiment of the present disclosure, storage device 200 may include instructions and/or data for configuring terminal 110 to perform one or more functions consistent with method 500. Further, storage module 250 may include instructions and/or data for configuring survey host 120 to perform one or more functions consistent with method 500.

Method 500 may begin at startup of terminal 110 (at 502). At 504, terminal processor 150 may initiate browser application 210, which may present an appropriate credential (e.g., a password, token and/or digital certificate, etc.) to server-side network interface 134 along with a request for content from survey host 120. For example, browser may request the initial content page 271 identified in address file 212 using an HTTP request to survey host 120. If the credential is accepted by host-side network interface 134, then the browser request may be delivered to survey host 120. Host application 280 may respond to the browser request by transmitting initial page 271 to terminal 110. Browser 210 may then display the initial page 271 and await the arrival of a survey respondent (at 506).

In an exemplary embodiment, browser 210 may sense the arrival of a respondent by sensing an input to input interface 144 (such as an input to touch screen 144a or keyboard 144b). When a respondent's input is sensed, browser 210 may transmit an indication of the input to survey host 120, and host application 280 may initiate wrapper 270 by linking browser 210 to first level wrapper page 272 (at 508).

Browser 210 may display first-level wrapper page 272 on display 143, and the respondent may traverse wrapper 270 by answering wrapper question 274a from first-level wrapper page 272 (at 510). For example, with respect to the exemplary first-level wrapper page of FIG. 4A, the respondent may choose the language (English, French or German) in which they would like the survey to be displayed, e.g., by actuating the appropriate response button 276a using input interface 144. Host application 280 may receive an indication of the respondent's response to first-level wrapper question 174a and initiate the corresponding link 278 to the appropriate wrapper page in the next level of wrapper 270.

As shown in the exemplary first-level wrapper table 272 of FIG. 4A, for example, the respondent has chosen to take a survey in the English language. Accordingly, host application 280 may actuate link 278a to the English-language final-level wrapper page 273a. Browser 210 may then display final-level wrapper page 273a on display 143, and the respondent may answer final-level wrapper question 274b by indicating whether they are an equipment owner or an equipment buyer. Host application 280 may receive an indication of the respondent's response to final-level wrapper question 174b and initiate the corresponding link 279 to the appropriate security questionnaire (at 512).

As shown in the exemplary final-level wrapper table 273 of FIG. 4B, for example, the respondent has indicated that they are an equipment buyer. Accordingly, host application 280 may actuate link 279a to the English-language buyer survey 260a. It should be noted that, in an exemplary embodiment of the present disclosure, survey questionnaires 260 may include more than one questionnaire that is appropriate for a given class of target respondents. In this case, host application may be configured to choose to initiate one questionnaire at random from among the plurality of appropriate questionnaires 260. Alternatively, host application 280 may be configured to cycle through the appropriate questionnaires by initiating each in turn.

In an exemplary embodiment of the present disclosure, host application 280 may initiate a survey questionnaire 260 by linking browser 210 to a random one of the survey pages 262 included in that questionnaire. For example, host application 280 may initiate questionnaire 260a by linking browser 210 to a random one of survey pages 262a-d. Alternatively, host application 280 may initiate a survey questionnaire by linking browser 210 to a first one of the survey pages 262 included in that questionnaire. For example, host application 280 may initiate questionnaire 260a by linking browser 210 to survey page 262a.

Browser 210 may display the initial page of the selected questionnaire, e.g., questionnaire 260a, on display 143 (at 514), and the respondent may traverse the selected questionnaire 260a by answering the question or questions 264 on each page 262a-d of questionnaire 260a. For example, the respondent may choose the appropriate answer or answers to each question and submit their response by actuating the corresponding response mechanism 266 using input interface 144.

Input interface 144 may transmit a signal to survey host 120 indicative of the respondent's answer to the survey question 264. For example, in the case of a touch screen interface 144a, input interface 140 may transmit a signal indicative of the location of the respondent's touch on display screen 143. Host application 280 may receive the indication of the respondent's answer to the survey question (at 516). Host application 280 may store the respondent's answer in results database 290 (at 518).

At 520, host application 280 may then determine whether the respondent has reached the end of the selected questionnaire. For example, host application 280 may determine whether all of the survey pages 262a-d in the selected questionnaire 260a have been presented to the respondent. If the respondent has not yet reached the end of questionnaire (520: No), then host application 280 may link browser 210 to one of the remaining survey pages 262 in the selected questionnaire 260. For example, host application 280 may link browser 210 to a random one of the remaining survey pages 262, as discussed above. Processing may then continue at 514. If the respondent has reached the end of the selected questionnaire, then host application 280 may terminate the survey session (520: Yes). In an exemplary embodiment, statistical analysis application 290 may then be initiated (at 522) to provide an updated report of the results in results database 290. Host application 280 may then return processing to 506 and await the next respondent.

### INDUSTRIAL APPLICABILITY

The presently disclosed systems and methods for administering surveys may provide a secure Internet-based network of touch-screen kiosks dedicated to market research. Systems and methods consistent with the present disclosure may allow businesses to conduct market research in a secure and cost effective manner. By hosting the survey questionnaires on a network, systems and methods consistent with the present disclosure allow survey questionnaires to be deployed to geographically distributed terminals with a minimum of effort and expense. By providing security applications that prevent unauthorized access to the survey questions and results, systems and methods consistent with the present disclosure allow survey sponsors to ask their customer's questions that may have previously been considered too revealing of their business plans. By preventing the survey terminals from accessing network content other than content that is related to the survey questionnaire, systems and methods consistent with the present disclosure prevent respondents from gaining access to content that is unrelated to their purpose.

The foregoing description of embodiments of the present disclosure has been presented for purposes of illustration and description. It is not exhaustive and does not limit the present disclosure to the precise form disclosed. Modifications and variations are possible in light of the above teachings or may be acquired from practicing of the present disclosure. While the exemplary methods have been described herein as a series of acts, the order of the acts may vary in other implementations consistent with the present disclosure. In particular, non-dependent acts may be performed in any order, or in parallel

What is claimed is:

1. A system for administering a survey questionnaire, the system comprising:
computer readable media for storing a plurality of content pages, the content pages including a survey questionnaire comprising a plurality of survey questions;
a host for hosting the plurality of content pages on a network, and for receiving and storing responses to survey questions;
a terminal for accessing the plurality of content pages over the network, the terminal comprising:
a browser application for accessing the plurality of content pages over the network;
a file identifying the plurality of content pages; and
a security application, the security application preventing the browser application from accessing network content other than the content pages identified in the file; and
a graphical user interface, the graphical user interface including:
a display for displaying a content page to a survey respondent; and
a user input device for providing an indication of a survey respondent's response to a survey question displayed on a content page, the browser application transmitting the response indication to the host over the network.

2. The system of claim 1, wherein the user input device comprises a touch screen interface, the touch screen interface providing an indication of a location where the survey respondent touches the touch screen interface, the host receiving the location indication.

3. The system of claim 1, wherein the network is the Internet.

4. The system of claim 1, wherein, after receiving a response indication with respect to a survey question on one of the plurality of content pages, the host links the browser application to a next one of the plurality of content pages in the survey questionnaire.

5. The system of claim 4, wherein the host chooses the next content page at random from among the content pages which have not yet been displayed during a survey session.

6. The system of claim 1, further comprising a firewall for allowing the terminal to access the content pages hosted by the host and preventing unauthorized access to the content pages.

7. A method for administering a survey questionnaire using a host and a terminal, the method comprising:
hosting a plurality of content pages on a network, the content pages including a survey questionnaire comprising a plurality of survey questions;
identifying the plurality of content pages in a file;
accessing the plurality of content pages over the network using a browser application at the terminal;
preventing the browser application from accessing network content other than the content pages identified in the file;
displaying a content page to a survey respondent at the terminal;
receiving, at the terminal, an indication of a survey respondent's response to a survey question displayed on a content page;
transmitting the response indication to the host over the network; and
receiving and storing the response to the survey question at the host.

8. The method of claim 7, wherein receiving a response indication comprises receiving an indication of a location where the survey respondent touches a touch screen at the terminal, the host receiving the location indication.

9. The method of claim 7, wherein the network is the Internet.

10. The method of claim 7, wherein, after receiving a response indication with respect to a survey question on one of the plurality of content pages, the host links the browser application to a next one of the plurality of content pages in the survey questionnaire.

11. The method of claim 10, wherein the host chooses the next content page at random from among the content pages which have not yet been displayed during a survey session.

12. The method of claim 7, further comprising preventing unauthorized access to the content pages at the host.

13. The method of claim 7, further comprising:
the content pages including a plurality of survey questionnaires; and
prior to displaying a content page to a survey respondent, receiving, at the host, an indication of a survey respondent's response to a screening question, the host choosing one of the plurality of survey questionnaires to administer based on the response to the screening question.

14. Computer-readable media containing instructions for configuring a host and a terminal to perform a method for administering a survey questionnaire, the method comprising:
hosting a plurality of content pages on a network, the content pages including a survey questionnaire comprising a plurality of survey questions;
identifying the plurality of content pages in a file;
accessing the plurality of content pages over the network using a browser application at the terminal;
preventing the browser application from accessing network content other than the content pages identified in the file;
displaying a content page to a survey respondent at the terminal;
receiving, at the terminal, an indication of a survey respondent's response to a survey question displayed on a content page;
transmitting the response indication to the host over the network; and
receiving and storing the response to the survey question at the host.

15. The method of claim 14, wherein receiving a response indication comprises receiving an indication of a location where the survey respondent touches a touch screen at the terminal, the host receiving the location indication.

16. The method of claim 14, wherein the network is the Internet.

17. The method of claim 14, wherein, after receiving a response indication with respect to a survey question on one of the plurality of content pages, the host links the browser application to a next one of the plurality of content pages in the survey questionnaire.

18. The method of claim 17, wherein the host chooses the next content page at random from among the content pages which have not yet been displayed during a survey session.

19. The method of claim 14, further comprising preventing unauthorized access to the content pages at the host.

20. The method of claim 14, further comprising:
storing a plurality of questionnaires on the computer readable media; and
prior to displaying a content page to a survey respondent, receiving, at the host, an indication of a survey respondent's response to a screening question, the host choosing one of the plurality of questionnaires to administer based on the response to the screening question.
